(19) United States
(12) Patent Application Publication
(10) Pub. No.: US 2011/0238723 A1
(43) Pub. Date: Sep. 29, 2011

(54) SYSTEMS AND METHODS FOR WEB DECODING

(75) Inventors: DANA WEINTRAUB, Tel Aviv (IL); DOR GROSS, Tel Aviv (IL); ITSIK HOROVITZ, Holon (IL); AMIR TETELBAUM, Haifa (IL)

(73) Assignee: VERINT SYSTEMS LTD., Herzliya Pituach (IL)

(21) Appl. No.: 13/016,998

(22) Filed: Jan. 29, 2011

(30) Foreign Application Priority Data
Jan. 31, 2010 (IL) 203628

(51) Int. Cl. G06F 15/16

(52) U.S. Cl. 709/201

(57) ABSTRACT

Reconstructing web sessions of target users may be performed by accepting communication packets exchanged over a network during at least one network session associated with a target user. The packets may be processed so as to identify web pages viewed by the target user during the network session and interactions between the target user and the viewed web pages. The network session may be reconstructed as viewed by the target user over time, based on the identified web pages and interactions. The reconstructed network session may be presented to an operator. The interactions may be identified by a pattern of one or more packets that matches a given interaction selected from a set of possible interactions that are available in a given viewed web page.

### FIELD OF THE DISCLOSURE

The present disclosure relates generally to network communication analysis, and particularly to methods and systems for reconstructing web sessions of target users.

### BACKGROUND OF THE DISCLOSURE

Some network communication analysis applications analyze network traffic in order to reconstruct network sessions conducted by certain network users. For example, Fox-IT (Delft, The Netherlands) offer a system called FoxReplay Analyst, which reconstructs Internet sessions of target users from intercepted Internet packets. The system is described in a white paper entitled “FoxReplay Analyst,” Revision 1.0, November, 2007, which is incorporated herein by reference.

### SUMMARY OF THE DISCLOSURE

An embodiment that is described herein provides a method for communication analysis, including:

accepting communication packets exchanged over a network during at least one network session associated with a target user;

processing the packets so as to identify web pages viewed by the target user during the network session and interactions between the target user and the viewed web pages;

reconstructing the network session as viewed by the target user over time, based on the identified web pages and interactions; and

presenting the reconstructed network session to an operator.

In some embodiments, identifying the interactions includes identifying in the packets a pattern of one or more packets that matches a given interaction selected from a set of possible interactions that are available for performing in a given viewed web page, and determining, responsively to the identified pattern, that the target user performed the given interaction while viewing the given viewed web page. In an embodiment, reconstructing the network session includes adding the given interaction to the reconstructed network session. Identifying the pattern may include simulating the possible interactions so as to generate respective simulated patterns of packet sequences, and searching in the packets for the pattern that matches one of the simulated patterns.

In a disclosed embodiment, identifying the interactions includes identifying one or more scripts in a given viewed web page that were invoked by the target user, and adding the identified scripts to the reconstructed network session. In an embodiment, the scripts include Asynchronous JavaScript And XML (AJAX) scripts. In another embodiment, identifying the interactions includes identifying one or more objects that are referenced by a given viewed web page and were loaded by the given viewed web page in response to one or more of the interactions, and adding the identified objects to the reconstructed network session. In yet another embodiment, reconstructing the network session includes generating a sequence of session steps, such that a given session step includes a given viewed web page, state information related to the given viewed web page, and a given packet sequence that matches the session step.

In some embodiments, processing the packets includes identifying in the packets input provided by the target user when viewing the web pages. Identifying the input may include identifying in the packets textual input entered by the target user into one or more text boxes in the viewed web pages, and adding the identified textual input to the reconstructed network session. In an embodiment, presenting the reconstructed network session includes presenting the interactions between the target user and the viewed web pages to the operator. Additionally or alternatively, presenting the reconstructed network session includes accepting from the operator a request to perform an interaction that was not performed by the target user in the network session, searching the packets for a pattern of one or more packets that matches a response to the requested interaction, and presenting the response to the operator. In some embodiments, identification of the viewed pages and interactions, and reconstruction of the network session, are carried out in a switching element in the network over which the packets are exchanged.

There is additionally provided, in accordance with an embodiment of the present invention, a system for communication analysis, including:

a memory, which is configured to store communication packets exchanged over a network during at least one network session associated with a target user; and

a processor, which is configured to process the packets so as to identify web pages viewed by the target user during the network session and interactions between the target user and the viewed web pages, and to reconstruct the network session as viewed by the target user over time, based on the identified web pages and interactions, and to output the reconstructed network session.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a system for web decoding, in accordance with an embodiment of the present disclosure;

FIG. 2 is a flow chart that schematically illustrates a method for web decoding, in accordance with an embodiment of the present disclosure; and

FIG. 3 is a block diagram that schematically illustrates a system for web decoding, in accordance with an alternative embodiment of the present disclosure.

### DETAILED DESCRIPTION OF EMBODIMENTS

### Overview

In some network communication analysis applications, it is of interest to reconstruct and view network sessions conducted by certain network users, referred to as target users. Reconstruction and viewing of network sessions can be used, for example, to track Internet activities of suspected terrorists, to detect employees who conduct illegitimate network sessions during working hours, or for any other purpose. Applications of this sort can be used, for example, by law enforcement agencies and other investigation bodies, as well as in enterprise systems. An enterprise application may comprise, for example, a gateway that monitors incoming and outgoing network traffic in order to detect network sessions that access prohibited web sites.

Embodiments that are described hereinbelow provide improved methods and systems for reconstructing and presenting network sessions conducted by target users. In some embodiments, a web decoding system analyzes communication packets that originate from a computer network, such as the Internet. The system processes the packets so as to identify web pages that were viewed by a certain target user during a network session.

In addition, the system automatically identifies, based on the packets, interactions between the target user and the viewed pages. Such interactions may comprise any suitable action performed by the target user with respect to a viewed page. The terms “actions performed by the target user” and “interactions between the target user and the viewed pages” are used interchangeably herein. Actions may comprise, for example, pressed buttons, clicked links and selections made in menus and drop-down lists. In some cases, web pages may comprise scripts or other applications that execute locally in the target user's browser, such as Asynchronous JavaScript® And XML (AJAX) scripts. Actions performed by the target user in such a page may have only local effects and may not generate network traffic. In some embodiments, the system identifies such actions heuristically, using techniques that are described herein.

Based on the identified web pages and actions, the system reconstructs the network session, as it was viewed by the target user over time. The reconstructed network session is presented to an operator. The operator may play the reconstructed session, so as to view the sequence of pages seen by the target user and the actions he or she performed. The operator may also manipulate the reconstructed session in various ways.

Rather than simply providing a list of web pages and objects that may have been accessed by the target user, the disclosed methods and systems present the actual flow of the session, including the specific actions performed by the target user and the responses received as a result of these actions. As a result, the operator is provided with an authentic look-and-feel of the session, as if he or she were watching over the target user's shoulder. Reconstructed sessions can be used as a powerful source of information regarding the target user, and/or as evidence of illegitimate activities in which the target user is involved.

Since the disclosed techniques are able to identify user actions in complex web pages that contain embedded scripts, they are particularly effective in reconstructing sessions that involve Web 2.0 applications.

### System Description

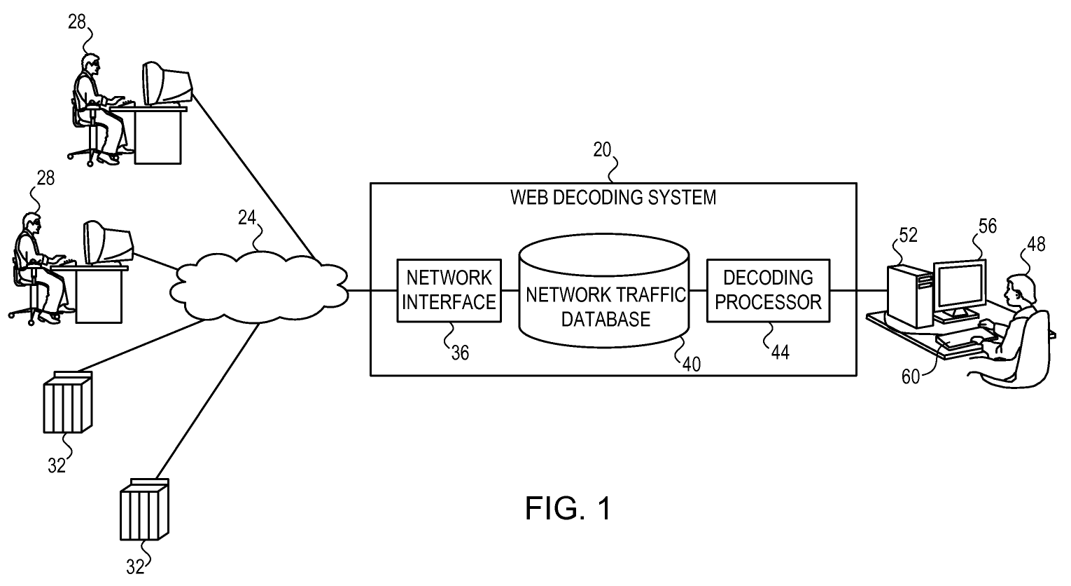

FIG. 1 is a block diagram that schematically illustrates a system 20 for web decoding, in accordance with an embodiment of the present disclosure. System 20 accepts communication packets from a computer network 24, in which users 28 conduct network sessions. The system processes the packets so as to reconstruct and present network sessions conducted by certain users 28 regarded as targets. In the embodiments described herein, network comprises the Internet. Alternatively, however, network 24 may comprise any other suitable computer network, such as an Intranet of a certain organization.

Users 28 conduct network sessions in network 24, such as by interacting with web servers 32. The users may browse web sites, exchange e-mail messages using web-based e-mail applications, use instant messaging applications, access forums, use web-based chat applications, use web-based file transfer and/or media (e.g., audio or video) transfer applications, surf web sites or conduct any other suitable kind of network session. Typically, users 28 conduct the network sessions by operating web browsers on their computers. During a given network session, the elements of network 24 (e.g., the user computer and the server with which the user computer communicates) generate packets, such as Hyper-Text Transfer Protocol (HTTP) request and reply packets. System 20 uses these packets to reconstruct network sessions, using methods that are described in detail below.

In the example of FIG. 1, system 20 comprises a network interface 36, a traffic database 40 and a decoding processor 44. Network interface 36 receives the packets from network 24, and the packets are stored in database 40 for analysis. In some embodiments, database holds the packets that are associated with certain target users. Typically, each packet is stored with a time stamp, which indicates the reception time of the packet. In some embodiments, each packet is indexed by the identity of the target user, the time stamp and a full Uniform Resource Locator (URL).

For a given target user, the packets associated with a certain web-site can be aggregated to form a web-site product, and the packets associated with a certain web-page can be aggregated to form a page product. When a certain main page contains another main page, both main pages are typically marked as the same page product but with different URLs. The system may terminate a certain web-site product after a certain silence period (a period in which no packets are received for this product) or when the product size exceeds a certain maximal value. Each product can be accompanied with certain metadata, referred to herein as Product Related Information (PRI). The PRI may comprise, for example, Internet Protocol (IP) addresses, ports, protocols, target user IDs, telephone numbers, file locations in the database, or any other suitable information.

Decoding processor 44 retrieves packets from database 40 and uses the packets to reconstruct network sessions of certain target users. The packets are typically arranged in database separately per user 28, so that processor 44 is able to access the packets associated with a given target user. The reconstructed sessions are presented to an operator, e.g., an analyst or investigator, on a display 56 of an operator terminal 52. The operator may manipulate the displayed session or otherwise provide input to system 20 using input devices 60, such as a keyboard or mouse.

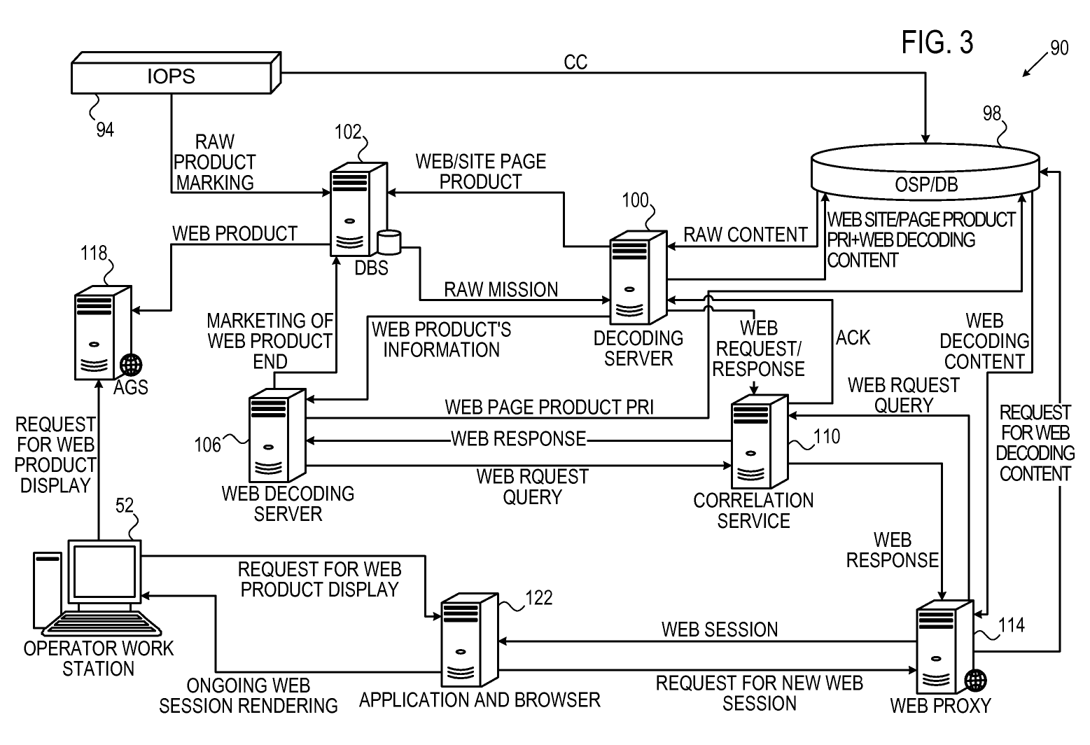

The system configuration of FIG. 1 is an example configuration, which is show purely for the sake of conceptual clarity. In alternative embodiments, any other suitable system configuration can also be used. For example, the functions of decoding processor 44 may be partitioned among multiple servers or other computing platforms. A configuration of this sort is shown in FIG. 3 further below. As another example, the functions of decoding processor 44 may be carried out by a switching element (e.g., network switch) of network 24.

### Reconstruction of Network Sessions from Communication Packets

System 20 reconstructs a network session associated with a target user by (1) identifying web pages that were viewed by the target user during the session, and (2) identifying the specific actions performed by the target user in the viewed pages. Actions that may be performed in web pages may comprise, for example, pressing buttons, clicking hyperlinks, marking check boxes, entering text in text boxes, selecting entries in menus and drop-down lists, and/or any other suitable actions.

The description that follows focuses on a single network session of a target user, i.e., an interaction of the target user with a single web site within a certain time period. Generally, however, system 20 may reconstruct multiple sessions for any given target user. Some sessions may overlap in time, e.g., when the target user interacts with different web-sites in separate browser windows or tabs. Processor 44 may distinguish between different sessions of a given target user, for example, based on the web-site with which the user communicates and the time stamps attached to the packets.

In a given session, processor 44 identifies the web pages viewed by the target user by analyzing the packets in database 40 that are associated with this user. For example, processor 44 may identify the web pages by extracting URLs or IP addresses from the HTTP requests and responses of the session. In some embodiments, processor 44 produces a sequence of main pages, in ascending order of their viewing time by the target user during the session. The term “main page” means a web page that is not dependent on a previous state of the web application it belongs to, and can be loaded to the user's browser at any given time using its URL.

In addition to constructing the sequence of main pages viewed by the target user, processor 44 identifies the actions performed by the target user in each main page. Typically, identifying the actions involves identifying input that is provided by the target user to the viewed pages. Some target user actions (e.g., clicking a hyperlink) may lead from one main page to another. Other actions (e.g., entering text in a text box and pressing an “OK” button) may generate certain traffic and invoke response from the web server involved in the session. Some actions may download an object that is referenced by the viewed page, such as a picture or video content. Other actions may invoke a script (e.g., an AJAX script) embedded in the page, without generating network traffic. The role of AJAX scripts and the processing of scripts using the disclosed techniques are described in detail further below.

Processor 44 identifies these actions, and presents the actions performed by the target user to the operator, as part of the reconstructed session. For example, processor 44 may color hyperlinks that were clicked by the target user in a distinct color, so as to distinguish them from other hyperlinks that were not clicked by the target user. As another example, processor 44 may present textual input that the target user entered, e.g., by populating the appropriate text boxes in the reconstructed session. As yet another example, when concluding that the target user made a certain selection in a menu or drop-down list, processor 44 may display this selection when presenting the reconstructed session. Additionally or alternatively, processor 44 may present the actual actions performed by the target user with respect to the viewed pages in any other suitable way.

Processor 44 may apply different techniques for identifying (or heuristically deducing) the actions performed by the target user in a given page, based on the packets in database 40. In some cases, an action that could have been performed by the target user causes generation of a certain pattern of one or more packets. A different possible action causes generation of a different pattern. For example, selecting different entries from a drop-down list may cause generation of different HTTP request/reply sequences. In some embodiments, processor 44 determines the actual action performed by the target user in the page by searching in database 40 for patterns that match the different possible actions. If a pattern that matches one of the possible actions is found, processor 44 may conclude that the target user performed this action.

In some embodiments, processor 44 simulates patterns of packets that match different actions, which are available for performing in a given page. Processor 44 then searches database 40 for actual patterns that match the simulated patterns. When a match is found, processor concludes that the target user is likely to have performed the corresponding action. In essence, this process is equivalent to attempting to perform the different available actions in a given page (e.g., press the different buttons, select different menu entries, click on different hyperlinks or enter different text strings in text boxes), and then trying to find in database 40 packets that match these attempts.

In some cases, a possible action that could have been performed by the target user causes download of an object that is referenced by the viewed page. For example, the target user may click a link that downloads an image or video content. In some embodiments, processor searches database 40 for packets indicating such download. If the packets in the database indicate that object download occurred, the processor may conclude that the target user is likely to have performed this action.

In some cases, a possible action that could have been performed by the target user causes the browser to load another main page. For example, a certain main page may contain a hyperlink that leads to another main page. In some embodiments, processor 44 may detect that a certain main page is loaded following another page that contains a link to the newly-loaded page, and therefore conclude that the target user clicked on that link. The processor may also identify HTTP requests/responses that indicate requesting and loading of the latter page.

In some cases, a given page may contain embedded scripts that execute locally in the user's browser and do not necessarily generate network traffic. In these cases, each page can be in different application states at different times and in response to different actions. In some embodiments, processor 44 identifies the application state of a given page at a given time (and thus the scripts invoked by the target user in the page) based on the packets in database 40. The identification may be performed, for example, uniquely for specific web pages or sites, or using heuristic methods.

Typically, processor 44 represents the reconstructed session as a sequence of steps. Each step in the sequence comprises a main page and the associated target user actions. In some embodiments, the target user actions are stored as a series of changes in the state information of the main page. When the web page is constructed using Document Object Model (DOM) elements, the target user actions can be stored as a series of changes in the DOM elements.

In some cases, a given viewed page contains one or more text boxes for entering text by the target user. In some embodiments, processor 44 identifies textual strings that were entered by the target user by extracting the textual strings from HTTP requests sent from the target user's browser. Processor 44 presents these strings as part of the reconstructed session.

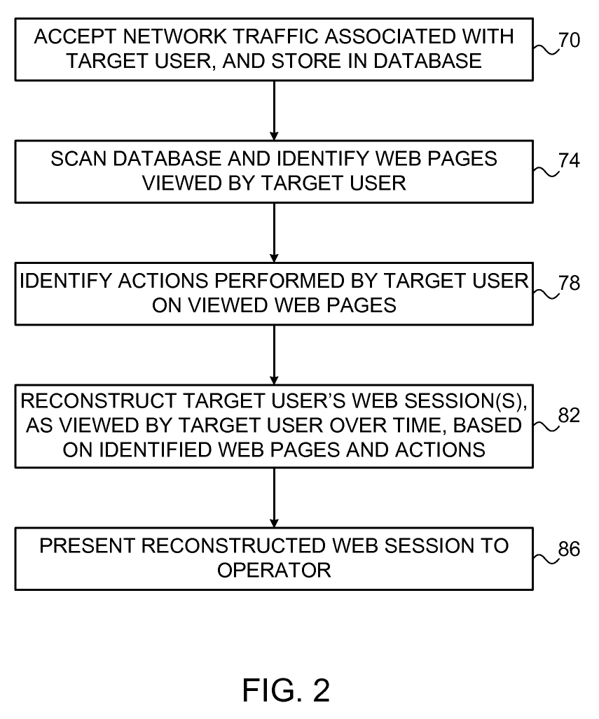

FIG. 2 is a flow chart that schematically illustrates a method for web decoding, in accordance with an embodiment of the present disclosure. The method begins with system 20 accepting packets from network 24 and storing the packets in database 40, at an input step 70. The description that follows refers to packets that are associated with a certain target user. Decoding processor 44 scans the packets in database 40 and identifies the web pages (“main pages”) viewed by the target user, at a page identification step 74. The processor orders the main pages in ascending order of viewing by the target user.

Based on the packets in database 40, processor 44 identifies the specific actions that were performed by the target user in each main page, at an action identification step 78. The processor may identify any of the above-mentioned example actions, using any of the identification techniques described above. Using the identified web pages and actions, processor 44 reconstructs the network session, as it was viewed by the target user, at a session reconstruction step 82. Processor 44 presents the reconstructed session to operator 48 using operator terminal 52, at an output step 86.

### Alternative System Configuration

FIG. 3 is a block diagram that schematically illustrates a system 90 for web decoding, in accordance with an alternative embodiment of the present disclosure. In the present example, packets originating from network are provided by an Input-Output Processing Server (IOPS) 94. The packets are stored in a database 98, which functions similarly to database 40 of FIG. 1 above.

The functionality of decoding processor 44 of FIG. 1 above is partitioned among a decoding server 100, a correlation service server 110, a database server (DBS) 102 and a web decoding server 106. This partitioning, however, is shown purely by way of example. In alternative embodiments, the system functions can be partitioned into any desired number of computing platforms in any suitable manner.

Decoding server 100 stores the packets associated with each target user in database 98, per target user. Each main page is typically marked in database 98 as a different product, along with the objects and scripts (e.g., AJAX scripts) associated with the page. A given main page may point to another main page as a related product if the later page was invoked by the former page (e.g., if the target clicked a static link in the former page). As explained above, server 100 identifies the main pages of the session and the target user actions in those pages, and reconstructs the session.

Correlation server 110 is sometimes integrated with decoding server 100 on the same computing platform. Server 110 typically holds a table with the different target users' web requests (e.g., up to 1G entries). The table may be partitioned by time (e.g., up to 10M entries in each partition). The oldest partition is typically purged when the maximum number of entries is reached. For each web request, server 110 typically holds information such as URL, target user ID, file location (full path or base path and relative path), time stamp of interception, indication whether the URL a main page by itself, or any other suitable information. Correlation server 110 is typically queried with fields such as URL, target user ID, time stamp of interception of the main page that originated the request (if the URL is itself a main page, then the time stamp will be the interception time stamp of this main page), and an indication whether the queried URL is a main page. Database 98 typically retains the stored packets for a long time period, often long after the decoded sessions have already been purged from the system. The stored packets can be re-processed on demand at any given time.

The correlation server responds to a query with the most appropriate result, according to the following logic: A URL that is a main page will have a result only upon an exact match of URL, target user ID and time stamp. A URL that is not a main page will be best matched according to the following priorities: (1) A matching request exists in the database for the same target user ID and has interception time that is within a certain time interval (e.g., 20-30 seconds) of the main page that is associated with the current request, and (2) a matching request exists in the database for the same target user ID and has an interception time that is smaller by less than X days from the time stamp of the main page that is associated with the current request. In this case, the request that will be returned is the closest in time to the time stamp of the main page. Variable X is configurable.

In some embodiments, the correlation server enables querying by target user ID and time stamp of interception of the main page, for example for coloring of static user links. In some embodiments, the correlation server will respond with all requests of the same target user ID that have interception times within a certain time (e.g., 20-30 seconds) of the time stamp of the main page that is associated to the current request.

Web decoding server 106 runs a separate process, which may comprise a heuristic process, for determining which of the available actions in a given page were actually performed by the target user. Server 106 typically queries correlation server 110 for new main pages. A main page in the correlation server will typically also point to its product's PRI. The web decoding server opens the main page in a browser, and finds all static links that point to existing web files in the packets associated with the target user. In some embodiments, server 106 may go back in the traffic database only up to a certain threshold (e.g., three days). Server 106 records the relationship between the link to the file in the product's PRI (or return it to decoding server 100 for writing in the PRI file).

In some embodiments, web decoding server 106 recursively attempts to invoke sequences of actions in web pages, and match them with the intercepted HTTP traffic that decoding server 100 has populated into correlation server 110. When the most probable sequence of actions is found, a mapping is created between sequences of DOM operations to a sequence of HTTP requests/responses. When a mapping of this sort is found, the web decoding server may write the mapping to the PRI of the main page. Alternatively, the web decoding server may return the mapping to decoding server 100 for marking in the PRI file. The identified sequence of actions is typically written as a step in the PRI.

In some embodiments, the web decoding server heuristically attempts to extract textual strings entered by the target user, and relate them to text boxes in the currently processed step. If a match is found, the textual string is written in the appropriate step in the PRI. When a main page product is found to have a relationship with another main page (e.g., because it is linked to the current page), it is entered as a step in the PRI that points to a related product. In other words, a URL of a page can be associated with a related product and not only with a file. A list of the related products is typically stored as part of the PRI. When the operator clicks such a link, an indication is generated that the application in server 122 is to switch to a different product. If a main page is found to contain another main page inside a frame, the contained main page is typically not be written as related product, but rather as part of the product.

When a page product is closed (e.g., following a silent period), the web decoding server marks it in database 98 with and “end of product” mark, possibly involving signaling to decoding server 100. Each web file that is found to relate to a main page is typically marked as such. For web files that are older than a certain configurable time and have no main page that relates to them, the web decoding server typically adds these files to a “Garbage Product.” The garbage product is typically managed by decoding server 100, and contains unrelated files of a given target user. The web decoding server may add a media type indication (e.g., audio or video) to a main page if one of the loaded links of the page (but not a related product) contains audio or video.

An application server 122 runs a browser application, which displays the reconstructed session on operator terminal 52. In addition to the session itself, the application running on server 122 supports a user interface that enables the operator to manipulate the session.

Application server 122 communicates with a web proxy server 114, which emulates the operation of network 24 vis-à-vis the browser application. When playing the reconstructed session, application server 122 sends HTTP requests to proxy server 114, and the proxy server responds with the appropriate HTTP responses. The responses are based on the packets stored in database 98, i.e., on the previously-acquired network traffic associated with the target user. The application on server 122 enhances the HTTP requests sent from the browser to proxy server 114 with the appropriate context (e.g., target user ID, session ID, ID of step in the session). The proxy uses this context information in order to search the database for the appropriate response.

In some embodiments, server 122 supports multiple browsers, such as Internet explorer, Firefox and/or Chrome. Server 122 typically enables displaying of multiple products sequentially, by deleting the browser cache between successive products. Server 122 may support real-time operation. In this mode, server 122 does not wait for the web decoding server to generate the PRI, but rather sends the requests originating from each main page to proxy server 114 for resolution. In some embodiments, each new product sent from application server 122 to proxy server 114 is accompanied with a token associated with the operator, so as to enable secure access to the proxy server.

In some embodiments, application server 122 supports off-line operation. In this mode, server 122 typically follows the PRI generated by web decoding server 106. Upon opening of a product, server 122 typically activates the browser with the main page, and sends the URL of the first HTTP request to the proxy server. The proxy server, using the correlation service, translates the URL into the file location of the product's PRI. The proxy server then loads the PRI, accesses the web file matching the first request, and responds with the correct response.

When the operator requests to proceed to the next session step (e.g., by pressing a “Next” button in the application), the application will jump to the next step of the PRI. Server 122 uses the information in the PRI to populate the text boxes, operate the sequence of DOM elements and send to the proxy server the product ID (as the session identifier) and step number together with the resulting HTTP request. When the main page contains other main pages inside frames, loading of these main pages will not cause the application to issue requests for change of product. When the operator clicks on a link to a related product, the application of server 122 typically provides the browser the parameters of the product it needs to switch to.

An Application Gateway server (AGS) 118 mediates between DBS 102 and the operator terminal. The AGS translates operator requests received from operator terminal 52 into database queries, queries DBS 102 with these queries, and then translates the query results and associated data into a format that is compatible with operator terminal 52.

Typically, processor 44 in FIG. 1 and servers 100, 102, 106, 110, 114, 118 and 122 in FIG. 3 comprise general-purpose computers, which are programmed in software to carry out the functions described herein. The software may be downloaded to the computers in electronic form, over a network, for example, or it may, alternatively or additionally, be provided and/or stored on tangible media, such as magnetic, optical, or electronic memory.

### Additional Embodiments and Variations

As noted above, application server 122 runs a browser application for presenting the reconstructed session to operator 48. In some embodiments, the browser application supports a user interface that allows the operator to manipulate the reconstructed session in various ways. For example, the operator may navigate (e.g., continuous play, play the next session step, cue, stop, pause, rewind, fast-forward or jump to a desired web page) in the reconstructed session. The operator may also reload a certain main page when desired.

When playing the reconstructed session, the operator can view the web pages that were viewed by the target user in the same sequence, as well as the specific actions performed by the target user in those pages. When the target user entered textual strings in text boxes, the browser application populates the text boxes in the reconstructed session. As a result, the operator can view the specific text entered by the target user, as well as the response invoked by this text.

In some embodiments, the browser application enables the operator to perform actions (e.g., press buttons or follow links) that were not originally performed by the target user. When the operator performs such an action, the application searches in the database for packets or objects that match the appropriate response. If such packets or objects are found, the application may perform the action as requested.

When viewing a certain main page in the reconstructed session, the operator may choose to take certain action (e.g., activate a screen object) instead of continuing to follow the session. In such a case, returning to following the reconstructed session will typically require reloading of the main page. In some cases, the operator may choose to enter text into a text box in one of the main pages. In such a case, the system may search in the database for a response that matches this input. If such a response is found in the previously-intercepted traffic, it will be presented to the operator.

The methods and systems described herein can be carried out in real-time or off-line. In off-line operation, the information in database 40 (or database 98) is static, and the target user session is reconstructed from this static information. In real-time operation, packets continue to flow from network 24 during reconstruction of the target user session. In this mode of operation, the system can reconstruct a session that is still in progress, at a certain delay. In some embodiments, the system reconstructs a given session in response to a request from operator 48. In alternative embodiments, the system can reconstruct sessions of designated target users irrespective of operator instructions.

In some embodiments, the system is able to reconstruct sessions conducted using various types of browsers, such as Internet Explorer, Firefox and Chrome. In some embodiments, the system supports traffic that is forwarded over proxy servers in network 24, such as Web or Socks proxies. In some embodiments, the system comprises means for protecting from security threats that may be introduced via the intercepted packets, and in particular via embedded scripts.

It will be appreciated that the embodiments described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art.

1. A method for communication analysis, comprising:
accepting communication packets exchanged over a network during at least one network session associated with a target user;
processing the packets so as to identify web pages viewed by the target user during the network session and interactions between the target user and the viewed web pages;
reconstructing the network session as viewed by the target user over time, based on the identified web pages and interactions; and
presenting the reconstructed network session to an operator.

2. The method according to claim 1, wherein identifying the interactions comprises identifying in the packets a pattern of one or more packets that matches a given interaction selected from a set of possible interactions that are available for performing in a given viewed web page, and determining, responsively to the identified pattern, that the target user performed the given interaction while viewing the given viewed web page.

3. The method according to claim 2, wherein reconstructing the network session comprises adding the given interaction to the reconstructed network session.

4. The method according to claim 2, wherein identifying the pattern comprises simulating the possible interactions so as to generate respective simulated patterns of packet sequences, and searching in the packets for the pattern that matches one of the simulated patterns.

5. The method according to claim 1, wherein identifying the interactions comprises identifying one or more scripts in a given viewed web page that were invoked by the target user, and adding the identified scripts to the reconstructed network session.

6. The method according to claim 5, wherein the scripts comprise Asynchronous JavaScript And XML (AJAX) scripts.

7. The method according to claim 1, wherein identifying the interactions comprises identifying one or more objects that are referenced by a given viewed web page and were loaded by the given viewed web page in response to one or more of the interactions, and adding the identified objects to the reconstructed network session.

8. The method according to claim 1, wherein reconstructing the network session comprises generating a sequence of session steps, such that a given session step comprises a given viewed web page, state information related to the given viewed web page, and a given packet sequence that matches the session step.

9. The method according to claim 1, wherein processing the packets comprises identifying in the packets input provided by the target user when viewing the web pages.

10. The method according to claim 9, wherein identifying the input comprises identifying in the packets textual input entered by the target user into one or more text boxes in the viewed web pages, and adding the identified textual input to the reconstructed network session.

11. The method according to claim 1, wherein presenting the reconstructed network session comprises presenting the interactions between the target user and the viewed web pages to the operator.

12. The method according to claim 1, wherein presenting the reconstructed network session comprises accepting from the operator a request to perform an interaction that was not performed by the target user in the network session, searching the packets for a pattern of one or more packets that matches a response to the requested interaction, and presenting the response to the operator.

13. The method according to claim 1, wherein identification of the viewed pages and interactions, and reconstruction of the network session, are carried out in a switching element in the network over which the packets are exchanged.

14. A system for communication analysis, comprising:
a memory, which is configured to store communication packets exchanged over a network during at least one network session associated with a target user; and
a processor, which is configured to process the packets so as to identify web pages viewed by the target user during the network session and interactions between the target user and the viewed web pages, and to reconstruct the network session as viewed by the target user over time, based on the identified web pages and interactions, and to output the reconstructed network session.

15. The system according to claim 14, wherein the processor is configured to identify in the packets a pattern of one or more packets that matches a given interaction selected from a set of possible interactions that are available for performing in a given viewed web page, and to determine, responsively to the identified pattern, that the target user performed the given interaction while viewing the given viewed web page.

16. The system according to claim 15, wherein the processor is configured to simulate the possible interactions so as to generate respective simulated patterns of packet sequences, and to identify the pattern by searching in the packets for the pattern that matches one of the simulated patterns.

17. The system according to claim 14, wherein the processor is configured to identify one or more scripts in a given viewed web page that were invoked by the target user, and to add the identified scripts to the reconstructed network session.

18. The system according to claim 14, wherein the processor is configured to identify one or more objects that are referenced by a given viewed web page and were loaded by the given viewed web page in response to one or more of the interactions, and to add the identified objects to the reconstructed network session.

19. The system according to claim 14, wherein the processor is configured to identify in the packets textual input entered by the target user into one or more text boxes in the viewed web pages, and to add the identifies textual input to the reconstructed network session.

20. The system according to claim 14, wherein the processor is configured to present the interactions between the target user and the viewed web pages to the operator in the reconstructed network session.
